(19) United States
(12) Patent Application Publication
(10) Pub. No.: US 2012/0037131 A1
(43) Pub. Date: Feb. 16, 2012

(54) PRESSURE WAVE SUPERCHARGER

(75) Inventors: Georg Glitz, Paderborn (DE); Jan Araszkiewicz, Paderborn (DE)

(73) Assignee: Benteler Automobiltechnik GmbH, Paderborn (DE)

(21) Appl. No.: 13/027,766

(22) Filed: Feb. 15, 2011

(30) Foreign Application Priority Data
Feb. 17, 2010 (DE) 102010008386.0-13

(51) Int. Cl. F02B 33/40; F04D 25/00

(52) U.S. Cl. 123/559.1

(57) ABSTRACT

A pressure wave supercharger for installation on an internal combustion engine of a motor vehicle includes a rotor casing having an inner surface, and a rotor received in the rotor casing. A coating is applied on the inner surface of the rotor casing for absorbing heat radiation. The rotor casing is surrounded by an insulation jacket.

### CROSS-REFERENCES TO RELATED APPLICATIONS

This application claims the priority of German Patent Application, Serial No. 10 2010 008 386.0-13, filed Feb. 17, 2010, pursuant to 35 U.S.C. 119(a)-(d), the content of which is incorporated herein by reference in its entirety as if fully set forth herein.

### BACKGROUND OF THE INVENTION

The present invention relates to a pressure wave supercharger for installation on an internal combustion engine of a motor vehicle.

The following discussion of related art is provided to assist the reader in understanding the advantages of the invention, and is not to be construed as an admission that this related art is prior art to this invention.

Internal combustion engines for motor vehicles are supercharged to increase efficiency. The gas exchange is improved during the intake cycle through increase of the charging degree of the cylinder. Supercharged engines consume less fuel compared to engines that are not charged. A supercharged motor is able to burn a same amount of air-fuel mixture as an engine with greater capacity, when the internal resistance is the same.

Supercharging systems to generate gas dynamic processes in closed gas channels for supercharging internal combustion engines are generally designated as pressure wave superchargers or pressure wave machines. Cell rotors used in pressure wave machines have typically a cylindrical configuration and have channels which have predominantly constant cross section and extend from the hot gas side to the cold gas side.

Current pressure wave superchargers encounter problems as a result of thermal stress to which all components of the cell rotor are exposed. Temperatures of up to 1100° C. can be experienced on the hot side of the cell rotor whereas the cold side is subject to a temperature of maximal 200° C. A warping, caused by heat, may be encountered, adversely affecting the efficiency of the pressure wave supercharger. To address this problem, calculations have been made that relate the thermal expansion of the rotor with the rotor casing to the operating conditions at hand so as to optimize a gap between the cell partitions of the rotor and rotor casing. Still, the rotor expands thermally to a greater degree than the rotor casing because during cold start the rotor is exposed to hot gas before the rotor casing.

The attainable efficiency of the pressure wave supercharger depends directly on the gap size between rotor and rotor casing so that the efficiency is greatly determined by the thermomechanical behavior of the involved components.

It would be desirable and advantageous to provide an improved pressure wave supercharger to obviate prior art shortcomings and to enhance efficiency thereof.

### SUMMARY OF THE INVENTION

According to one aspect of the present invention, a pressure wave supercharger for installation on an internal combustion engine of a motor vehicle includes a rotor casing having an inner surface, a rotor received in the rotor casing, and a coating applied on the inner surface of the rotor casing for absorbing heat radiation.

The present invention resolves prior art problems by applying a coating for absorption of heat radiation on the inner surface of the rotor casing. As a result, the inner surface of the rotor casing heats up not only because of convection of hot gas flowing through the cell compartments but also because of the absorbed heat radiation of the hot gas and heat radiation of the rotor. In the description, the term “coating” to absorb heat radiation relates to a coating by which the inner surface of the rotor casing is configured substantially as black body or full radiator. Heat radiation emitted by hot gas and the rotor is thus converted on the inner surface of the rotor casing into heat. This can be optimized by the coating so that a maximum of heat radiation can be absorbed.

The temperature differential between rotor and rotor casing is thus reduced. The gap there between can hence be sized smaller because the rotor and rotor casing expand in proportional relationship. As the gap can now be made smaller, efficiency is increased.

According to another advantageous feature of the present invention, the rotor casing has an outer side exhibiting a surface roughness which can be made smaller than a surface roughness of the inner surface. As heat is absorbed by heat radiation and convection, a heat conduction is established within the rotor casing. Heat follows a temperature gradient which is oriented to a colder outer side of the rotor casing. Thus, heat is removed from the rotor casing on the outer side thereof through convection and heat radiation, causing the rotor casing to cool down.

To minimize heat emission on the outer side of the rotor casing as heat energy contained in the rotor casing is converted into heat radiation, the outer side of the rotor casing has a smallest possible surface roughness. A surface with smallest possible surface roughness is hereby to be understood within the scope of the invention in the context of a metal sheet as relating to a rolled smooth surface. The surface may however have also a slight surface roughness to render it as reflective as possible. As a result, a maximum of heat conducted through the rotor casing and energy converted on the surface into heat radiation is reflected into the material thereof. Emission of heat radiation on the outer side of the rotor casing is minimized by the surface condition in accordance with the present invention.

According to another advantageous feature of the present invention, the outer side of the rotor casing has a region which can undergo a mechanical and/or chemical and/or physical treatment. In order for the surface condition of the rotor casing to be optimized in regard to a reflective heat radiation after undergoing the manufacturing process, the surface roughness can be further modified. Examples of mechanical treatment include surface polishing which may further be enhanced through additives, e.g. a burnishing agent. Examples of chemical treatment include surface etching or chemical vapor deposition. Examples of physical treatment include physical vapor deposition.

According to another advantageous feature of the present invention, the region of the outer side of the rotor casing can be realized by a coating process. The manufactured component of the rotor casing may be coated absent any further coating of the outer side such that the coating minimizes dissipation of heat energy via the outer side of the rotor casing through heat radiation. The coating may also be applied in addition to a treated surface. It is, of course, also conceivable to treat the surface of the coating itself by a further process.

According to another advantageous feature of the present invention, an insulation jacket is provided to surround the rotor casing. The insulation jacket assumes hereby the function to additionally thermally insulate the rotor casing against the surroundings. Heat dissipation through convection or heat radiation across the surface of the rotor casing is further minimized by the insulation jacket. As a result, only a minor part of heat is emitted from the rotor casing to the surroundings, in particular during the heat-up phase of the pressure wave supercharger. Thus, the rotor casing heats up faster and reaches an optimal operating temperature which is best suited to the rotor and allows the formation of an optimum gap size between rotor and rotor casing.

According to another advantageous feature of the present invention, the insulation jacket has an inner side and an outer side, with the inner and outer sides of the insulation jacket having a surface roughness which can be made smaller than a surface roughness of the inner surface of the rotor casing. The term “surface roughness” again relates to a rolled smooth surface which is as reflective as possible for reflection of heat radiation. The inner side of the insulation jacket reflects back heat emitted from the rotor casing so that the rotor casing is able to more rapidly heat up, in particular during the warmup phase.

The reflective or metallically smooth surface on the outer side of the insulation jacket has the same effect as the surface condition on the outer side of the rotor casing. Heat energy contained in the insulation jacket is prevented on the outer side of the insulation jacket to dissipate from the insulation jacket in the form of heat radiation. As a result, there is a smaller temperature gradient in the insulation jacket so that less heat is emitted from the rotor casing via the insulation jacket to the surroundings.

According to another advantageous feature of the present invention, the insulation jacket and the rotor casing can define an air gap there between. The air gap provides an additional insulation layer between the outer side of the rotor casing and the inner side of the insulation jacket in view of the small heat conductivity of air. This promotes a more rapid heat-up of the rotor casing.

According to another advantageous feature of the present invention, the insulation jacket may be made of a metallic material. The components of the pressure wave supercharger heat up to a maximum temperature of about 100° C. to 400° C. whereas the hot gases conveyed by the exhaust into the pressure wave supercharger have a temperature of up to 1100° C., and the immediate surroundings of the internal combustion engine lies in a temperature range of about 70° C. to 130° C. operating temperature. The metallic material of the insulation jacket has thus a particular positive effect on the service life of the insulation jacket.

According to another advantageous feature of the present invention, the rotor casing is made of a material defined by a thermal expansion coefficient which can be greater than or equal to a thermal expansion coefficient of a material of the rotor. As the components are exposed to heat energy, they undergo a thermal expansion. In view of their different configuration and different contact intensity with hot gas, the expansion of the various components is antiproportional in relation to one another. When the thermal expansion coefficient of the rotor casing is equal to or greater than the thermal expansion coefficient of the rotor, the risk of seizing of the rotor in the rotor casing is eliminated even when the gap size between rotor and rotor casing is minimal. The at least same or greater thermal expansion coefficient of the rotor casing promotes a faster expansion of the rotor casing in the warm-up phase in relation to the rotor so that a previously calculated optimum gap can be established between rotor and rotor casing during normal operation.

### BRIEF DESCRIPTION OF THE DRAWING

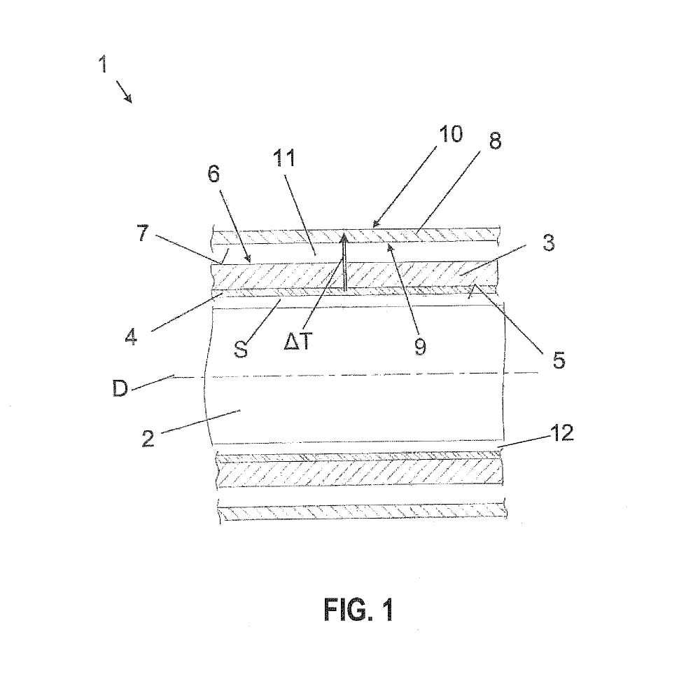

Other features and advantages of the present invention will be more readily apparent upon reading the following description of currently preferred exemplified embodiments of the invention with reference to the accompanying drawing, in which the sole FIG. 1 shows a simplified sectional cutaway view of a pressure wave supercharger according to the present invention.

### DETAILED DESCRIPTION OF PREFERRED EMBODIMENTS

The depicted embodiment is to be understood as illustrative of the invention and not as limiting in any way. It should also be understood that the figure is not necessarily to scale. In certain instances, details which are not necessary for an understanding of the present invention or which render other details difficult to perceive may have been omitted.

Turning now to FIG. 1, there is shown a simplified sectional cutaway view of a pressure wave supercharger according to the present invention, generally designated by reference numeral 1. The pressure wave supercharger 1 includes an internal rotor 2 and a rotor casing 3 in surrounding relationship to the rotor 2. At operation, the rotor 2 rotates rotationally-symmetrical about a rotation axis D. The rotor casing 3 is securely fixed to an internal combustion engine (not shown). Provided between the rotor 2 and the rotor casing 3 is a gap 12 which can be dimensioned in accordance with the present invention as minimally as possible without risking a seizing of the rotor 2 in the rotor casing 3.

In accordance with the present invention, the rotor casing 3 has an inner surface 5 to which a coating 4 is applied for absorption of heat radiation. Thus, heat radiation emitted from the rotor 2 and from hot gas in the pressure wave supercharger 1 is absorbed by the coating 4 on the inner surface 5 of the rotor casing 3.

Heat energy absorbed via the inner surface 5 of the rotor casing 3 results in a temperature gradient ΔT in the rotor casing 3 from the inner surface 5 to an outer side 6 of the rotor casing 3. The temperature gradient ΔT provides heat conduction within the rotor casing 3 and causes emission of heat in the form of convection and heat radiation across a surface 7 of the outer side 6 of the rotor casing 3. The surface 7 of the outer side 6 is smooth and in particular reflective so that a maximum of heat radiation emitted from the rotor casing 3 is reflected back into the rotor casing 3.

As further shown in FIG. 1, the rotor casing 3 is surrounded by an insulation jacket 8. The insulation casing 8 has an inner side 9 and an outer side 10 which both have a surface which is also as smooth as possible and in particular reflective. The inner side 9 of the insulation jacket 8 reflects heat radiation emitting via the outer side 6 of the rotor casing 3 back to the outer side 6. The outer side 10 of the insulation jacket 8 assumes a same function as the outer side 6 of the rotor casing 3, i.e. it reflects a maximum of heat radiation generated by the insulation jacket 8 back into the insulation jacket 8.

FIG. 1 further shows the presence of an air gap 11 between the rotor casing 3 and the insulation jacket 8. Due to a slight heat conductibility of air, the air gap 11 further promotes a thermal insulation of the rotor casing 3.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A pressure wave supercharger for installation on an internal combustion engine of a motor vehicle, comprising:
a rotor casing having an inner surface;
a rotor received in the rotor casing; and
a coating applied on the inner surface of the rotor casing for absorbing heat radiation.

2. The pressure wave supercharger of claim 1, wherein the rotor casing has an outer side exhibiting a surface roughness which is smaller than a surface roughness of the inner surface.

3. The pressure wave supercharger of claim 2, wherein the outer side of the rotor casing has a region which underwent a mechanical and/or chemical and/or physical treatment.

4. The pressure wave supercharger of claim 3, wherein the region of the outer side of the rotor casing is realized by a coating process.

5. The pressure wave supercharger of claim 1, further comprising an insulation jacket in surrounding relationship to the rotor casing.

6. The pressure wave supercharger of claim 5, wherein the insulation jacket has an inner side and an outer side, said inner and outer sides of the insulation jacket having a surface roughness which is smaller than a surface roughness of the inner surface of the rotor casing.

7. The pressure wave supercharger of claim 5, wherein the insulation jacket and the rotor casing define an air gap there between.

8. The pressure wave supercharger of claim 5, wherein the insulation jacket is made of a metallic material.

9. The pressure wave supercharger of claim 1, wherein the rotor casing is made of a material defined by a thermal expansion coefficient which is greater than or equal to a thermal expansion coefficient of a material of the rotor.
